(19) United States
(12) Patent Application Publication
(10) Pub. No.: US 2026/0359334 A1
(43) Pub. Date: Nov. 12, 2026

(54) COMPUTER-IMPLEMENTED METHOD FOR OBTAINING A FIRST SEARCH ITEM AND A SECOND SEARCH ITEM

(71) Applicant: ELISA OYJ, Helsinki (FI)

(72) Inventors: Ville RUUTU, Helsinki (FI); Jussi RUUTU, Helsinki (FI)

(73) Assignee: ELISA OYJ, Helsinki (FI)

(21) Appl. No.: 19/131,893

(22) PCT Filed: Nov. 1, 2023
(86) PCT No.: PCT/FI2023/050605

§ 371 Date: May 21, 2025

(30) Foreign Application Priority Data
Nov. 22, 2022 (FI) 20226042

(51) Int. Cl. G06F 16/334; G10L 15/08

(52) U.S. Cl. CPC G06F 16/3344; G10L 15/08; G10L 2015/081

(57) ABSTRACT

According to an embodiment, a computer-implemented method for obtaining a first search item and a second search item from text data, the method comprising: obtaining text data comprising a plurality of sections; searching for a first anchor section in the plurality of sections; dividing the text data into a first part and a second part based on a location of the first anchor section in the plurality of sections; searching for the second anchor section in the first part, and obtaining the first search item based at least on at least one location of the second anchor section in the first part; and searching for the second anchor section in the second part, and obtaining the second search item based at least on at least one location of the second anchor section in the second part.

### TECHNICAL FIELD

The present disclosure relates to language processing, and more particularly to a computer-implemented method for obtaining a first search item and a second search item from text data, a computing device, and a computer program product.

### BACKGROUND

As communication channels digitize, the amount of text-form data increases in the form of, for example, email, chat applications, and social networks. Further-more, speech-to-text technologies enable the conversion of speech data to text data. These factors also increase the need to process data that is in text form and to be able to find information within the data even when the same information can take various different forms in the text.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

It is an objective to provide a computer-implemented method for obtaining a first search item and a second search item from text data, a computing device, and a computer program product. The foregoing and other objectives are achieved by the features of the independent claims. Further implementation forms are apparent from the dependent claims, the description and the figures.

According to a first aspect, a computer-implemented method for obtaining a first search item and a second search item from text data comprises obtaining text data comprising a plurality of sections; searching for a first anchor section in the plurality of sections; in response to finding the first anchor section in the plurality of sections, dividing the text data into a first part and a second part based on a location of the first anchor section in the plurality of sections; in response to not finding the first anchor section in the plurality of sections, searching for a second anchor section in the plurality of sections and dividing the text data into the first part and the second part based at least on at least one location of the second anchor section in the plurality of sections; searching for the second anchor section in the first part, and in response to finding at least one of the second anchor section in the first part, obtaining the first search item based at least on at least one location of the second anchor section in the first part; searching for the second anchor section in the second part, and in response to finding at least one of the second anchor section in the second part, obtaining the second search item based at least at least one location of the second anchor section in the second part; and utilising the first search item and the second search item in an automatic speech recognition system. The method can, for example, efficiently search for the first search item and the second search item in the text data.

In an implementation form the first aspect, the first anchor section correspond to a synonym list of a first anchor symbol and/or the second anchor section correspond to a synonym list of a second anchor symbol. The method can, for example, efficiently search for the first search item and the second search item in the text data based on the first anchor symbol and/or the second anchor symbol.

In another implementation form the first aspect, the first search item corresponds to a username part of an email address or of a remote login address, the second search item correspond to a domain part of an email address or of a remote login address, the first anchor section corresponds an @-symbol, and the second anchor section corresponds to a dot symbol; or the first search item and the second search item correspond to a social security number, a vehicle registration number, a product code, or a client number. The method can, for example, efficiently search for such structured information in the text data.

In another implementation form the first aspect, the method further comprises: in response to not finding the first anchor section in the plurality of sections, dividing the text data into the first part and the second part based further at least on a number of sections in the text data and/or probability information about the text data. The method can, for example, efficiently search for the first search item and the second search in situations where the first anchor section cannot be found.

In another implementation form the first aspect, the method further comprises: obtaining name data and obtaining the first search item based further at least on a third anchor section corresponding to the name data; and/or obtaining domain data and obtaining the second search item based further at least on a fourth anchor section corresponding to the domain data. The method can, for example, efficiently search for the first search item and the second search item in the text data by utilising the name data and/or the domain data.

In another implementation form the first aspect, the method further comprises, in response to not finding at least one of the second anchor section in the first part, obtaining the first search item based at least on a number of sections in the first part. The method can, for example, efficiently search for the first search item in the first part in situations where the second anchor section cannot be found in the first part.

In another implementation form the first aspect, the method further comprises, in response to not finding at least one of the second anchor section in the second part, obtaining the second search item based at least on a number of sections in the second part. The method can, for example, efficiently search for the second search item in the second part in situations where the second anchor section cannot be found in the second part.

In another implementation form the first aspect, the obtaining the first search item based at least on the at least one location of the second anchor section in the first part comprises: dividing the first part into a first plurality of subparts according to the at least one location of the second anchor section in the first part; and obtaining the first search item by placing at least one second anchor symbol between two subparts in the first plurality of subparts. The method can, for example, efficiently obtain the first search item from the first part.

In another implementation form the first aspect, the method further comprises, in response to not finding at least one of the second anchor section in the first part, dividing the first part into the first plurality of subparts according to sections in the first part. The method can, for example, efficiently obtain the first search item from the first part in situations where the second anchor section cannot be found in the first part.

In another implementation form the first aspect, the obtaining the second search item based at least on at least one location of the second anchor section in the second part comprises: dividing the second part into a second plurality of subparts according to the at least one location of the second anchor section in the second part; and obtaining the second search item by placing at least one second anchor symbol between two subparts in the second plurality of subparts. The method can, for example, efficiently obtain the second search item from the second part.

In another implementation form the first aspect, the method further comprises, in response to not finding at least one of the second anchor section in the second part, dividing the second part into the second plurality of subparts according to sections in the second part. The method can, for example, efficiently obtain the second search item from the second part in situations where the second anchor section cannot be found in the second part.

In another implementation form the first aspect, the obtaining the text data comprises: obtaining speech data; and obtaining the text data by converting the speech data into the text data using a speech-to-text conversion. The method can, for example, efficiently search for the first search item and the second search item in the text data when the text data is obtained based on speech data.

According to a second aspect, a computing device comprises at least one processor and at least one memory including computer program code, the at least one memory and the computer program code being configured to, with the at least one processor, cause the computing device to perform the method according to the first aspect.

According to a third aspect, a computer program product comprises program code configured to perform the method according to the first aspect when the computer program product is executed on a computer.

Many of the attendant features will be more readily appreciated as they become better understood by reference to the following detailed description considered in connection with the accompanying drawings.

### DESCRIPTION OF THE DRAWINGS

In the following, example embodiments are described in more detail with reference to the attached figures and drawings, in which:

FIG. 1 illustrates a flow chart representation of a method according to an embodiment;

FIG. 2 illustrates a flow chart representation of a method according to another embodiment;

FIG. 3 illustrates a flow chart representation of a method according to another embodiment;

FIG. 4 illustrates a schematic representation of a preconfigured structure according to an embodiment;

FIG. 5 illustrates a table of text data and corresponding usernames and domains according to an embodiment; and

FIG. 6 illustrates a schematic representation of a computing device according to an embodiment.

In the following, like reference numerals are used to designate like parts in the accompanying drawings.

### DETAILED DESCRIPTION

In the following description, reference is made to the accompanying drawings, which form part of the disclosure, and in which are shown, by way of illustration, specific aspects in which the present disclosure may be placed. It is understood that other aspects may be utilised, and structural or logical changes may be made without departing from the scope of the present disclosure. The following detailed description, therefore, is not to be taken in a limiting sense, as the scope of the present disclosure is defined be the appended claims.

For instance, it is understood that a disclosure in connection with a described method may also hold true for a corresponding device or system configured to perform the method and vice versa. For example, if a specific method step is described, a corresponding device may include a unit to perform the described method step, even if such unit is not explicitly described or illustrated in the figures. On the other hand, for example, if a specific apparatus is described based on functional units, a corresponding method may include a step performing the described functionality, even if such step is not explicitly described or illustrated in the figures. Further, it is understood that the features of the various example aspects described herein may be combined with each other, unless specifically noted otherwise.

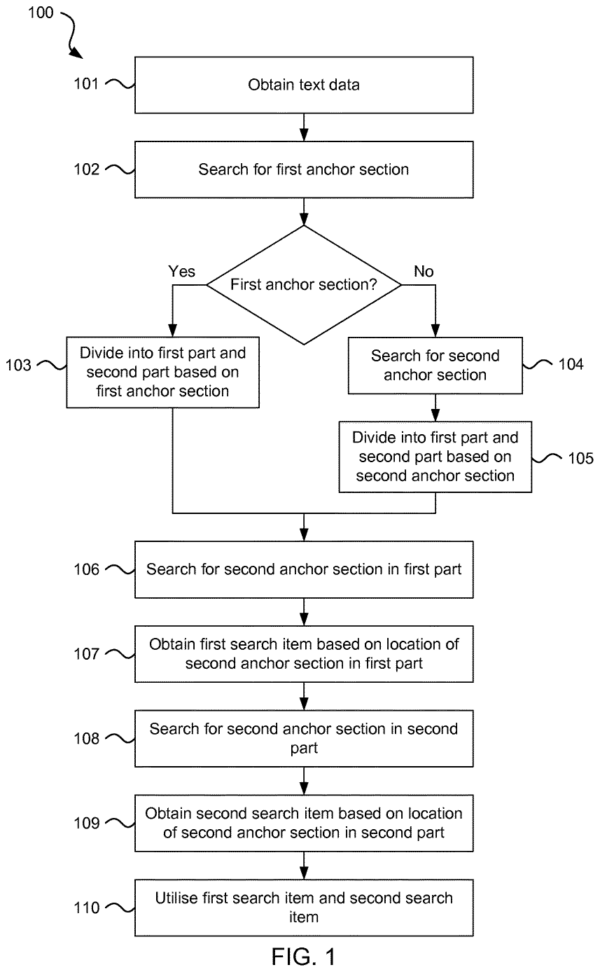

FIG. 1 illustrates a flow chart representation of a method according to an embodiment.

According to an embodiment, a computer-implemented method 100 for obtaining a first search item and a second search item from text data comprises 101 obtaining text data comprising a plurality of sections.

Each section in the plurality of sections may comprise, for example a word, a character/symbol string, and/or a symbol. In some cases, a symbol may be represented by a corresponding word in the plurality of sections. For example a dot symbol may be represented by the word “dot”, or the @-symbol may be represented by the words “at” or “address sign”. In some cases, a symbol may be represented by a corresponding word in any language in the plurality of sections. For example a dot symbol may be represented by the Finnish word “piste”, or the @-symbol may be represented by the Finnish words “ät” or “miukumauku”.

The method 100 may further comprise searching 102 for a first anchor section in the plurality of sections.

The method 100 may further comprise, in response to finding the first anchor section in the plurality of sections, dividing 103 the text data into a first part and a second part based on a location of the first anchor section in the plurality of sections.

The method 100 may further comprise, in response to not finding the first anchor section in the plurality of sections, searching 104 for a second anchor section in the plurality of sections and dividing 105 the text data into the first part and the second part based at least on at least one location of the second anchor section in the plurality of sections.

The first anchor section and/or the second anchor section may comprise, for example, any preconfigured word or symbol.

The method 100 may further comprise, searching 106 for the second anchor section in the first part, and in response to finding at least one of the second anchor section in the first part, obtaining 107 the first search item based at least on at least one location of the second anchor section in the first part.

The method 100 may further comprise, searching 108 for the second anchor section in the second part, and in response to finding at least one of the second anchor section in the second part, obtaining 109 the second search item based at least on at least one location of the second anchor section in the second part.

The method 100 may further comprise utilising 110 the first search item and the second search item in an automatic speech recognition (ASR) system.

The method 100 may be used to obtain needed information, such as an email address, a social security number, a vehicle registration number, a product code, or a client number, from the text data. The ASR system may further process the found information. The ASR system can, for example, ask questions about, for example, basic information from a customer in a customer service situation over the phone, obtain the answers using the method 100 as the first search item and the second search item, and save the information in a system.

According to an embodiment, the first anchor section correspond to a synonym list of a first anchor symbol and/or the second anchor section correspond to a synonym list of a second anchor symbol.

For example, if the first anchor symbol comprises the @-symbol, the synonym list of the first anchor symbol may comprise any number of corresponding words any number of languages such as “at”, “at”, “miukumauku”, and so on. Similarly, if the second anchor symbol comprises the dot symbol, the synonym list of the second anchor symbol may comprise any number of corresponding words any number of languages such as “dot”, “piste”, and so on.

According to an embodiment, the obtaining the text data comprises: obtaining speech data; and obtaining the text data by converting the speech data into the text data using a speech-to-text conversion.

The speech data also be referred to as audio data, audio information, an audio file, or similar.

The speech data may comprise, for example, a batch of audio as an audio file or a continuous audio stream.

According to an embodiment, the method 100 further comprises: obtaining name data and obtaining the first search item based further at least on a third anchor section corresponding to the name data; and/or obtaining domain data and obtaining the second search item based further at least on a fourth anchor section corresponding to the domain data.

The name data may comprise, for example, information about a name of a user. Thus, such information can be used to more efficiently find the username, correspond to the first search item, in the text data. For example, if the name data indicates that the name of the user is “Teppo Testaaja”, the method 100 may comprise searching of the words “Teppo” and/or “Testaaja” in the text data.

The domain data may comprise, for example, information about a domain of a service provider of a user. For example, if the email address is provided by a specific service provider, the domain is likely to comprise the name of the service provider. Thus, such information can be used to more efficiently find the domain, correspond to the second search item, in the text data.

The method 100 may be able to find the first search term and the second search term from the text data. The method 100 may be able to efficiently find the first search term and the second search term from the text data when the text data comprises non-structured text data, such as text data from a speech-to-text conversion.

At least some embodiments may improve the searching of email addresses and similar information from the text data.

At least some embodiments may improve the capability of speech bots and/or similar speech-based systems to sparse email addresses and similar information from speech data in, for example, customer service situations.

At least some embodiments may be able to search email addresses and similar information from the text data in a manner that can be implemented with various technical systems and techniques.

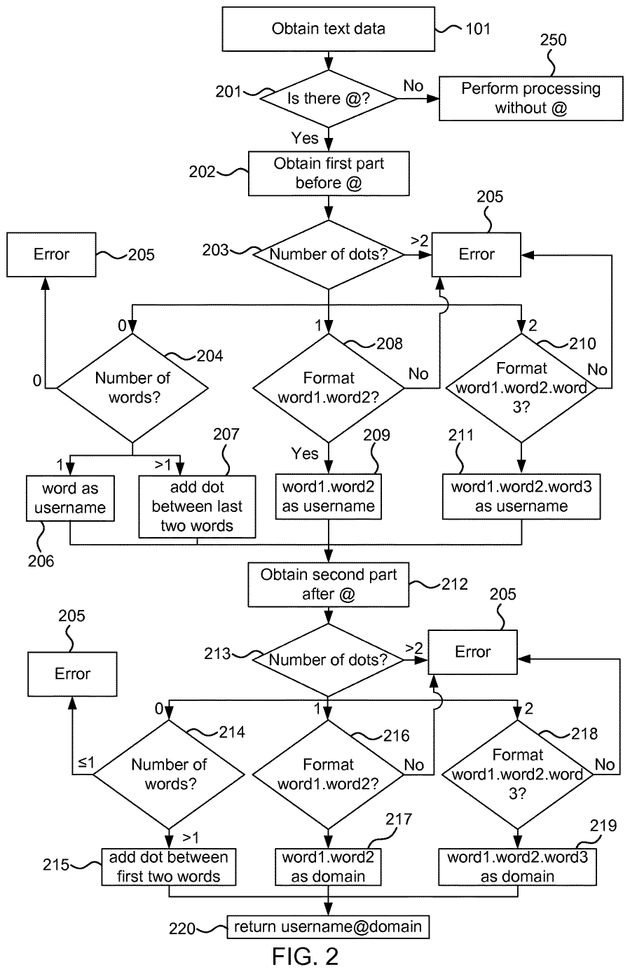

FIG. 2 illustrates a flow chart representation of a method according to another embodiment.

According to an embodiment, the first search item corresponds to a username part of an email address or of a remote login address, the second search item correspond to a domain part of an email address or of a remote login address, the first anchor section corresponds an @-symbol, and the second anchor section corresponds to a dot symbol.

For example, in the embodiment of FIG. 2, the first search item corresponds to a username part of an email address, the second search item correspond to a domain part of the email address, the first anchor section corresponds an @-symbol, and the second anchor section corresponds to a dot symbol.

The remote login address may comprise, for example, an address used to log into a remote device, such as a computer, using, for example, Secure Shell Protocol (SSH). The remote login address may be, for example, of the form “username@hostname” or similar.

According to an embodiment, the first search item and the second search item correspond to a social security number, a vehicle registration number, a product code, or a client number.

For example, in a vehicle registration number the first search item and the second search item may correspond to parts of the registration number separated by the first anchor section. For example, Finnish vehicle registration numbers, the first search item may correspond to the character part, the second search item may correspond to the number part, and the first anchor section may correspond to a dash symbol.

After obtaining 101 the text data, the method 100 can comprise checking 201 whether the text data comprises a @-symbol.

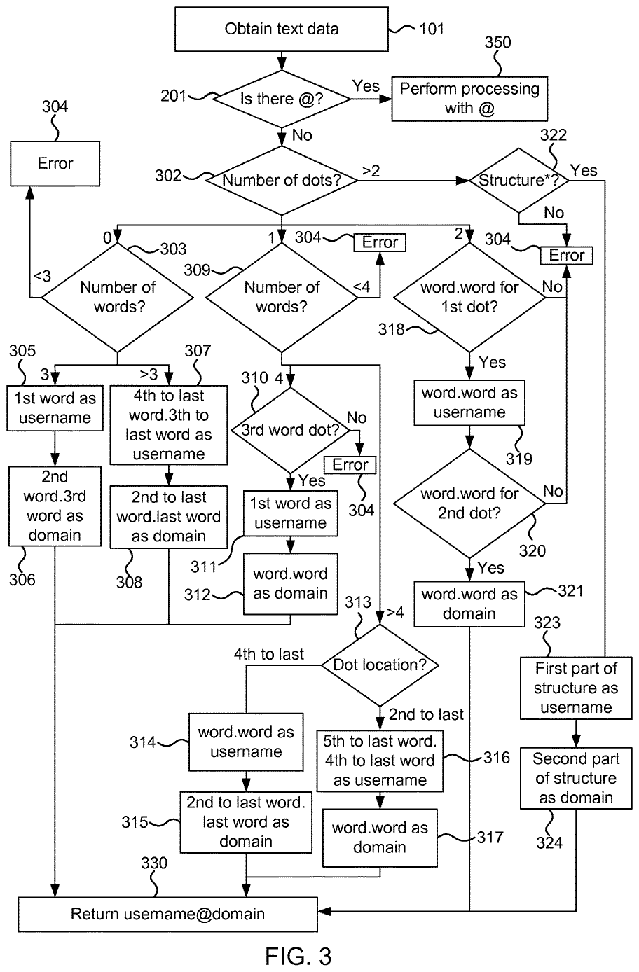

The method 100 may comprise, in response to the text data not comprising a @-symbol, performing 250 appropriate processing for text data without a @-symbol. An example of such processing is disclosed in the embodiment of FIG. 3.

The method 100 may comprise, in response to the text data comprising a @-symbol, obtaining 202 the first part before the @-symbol.

The method 100 may further comprise determining 203 a number of dot symbols in the first part. The method 100 may utilise a synonym list when determining 203 the number of dot symbols in the first part. The synonym list may comprise a plurality of words that correspond to the dot symbol.

According to an embodiment, the method 100 further comprises, in response to not finding at least one of the second anchor section in the first part, obtaining the first search item based at least on a number of sections in the first part.

According to an embodiment, the method 100 further comprises, in response to not finding at least one of the second anchor section in the first part, dividing the first part into the first plurality of subparts according to sections in the first part.

For example, in the embodiment of FIG. 2, when no dot symbols are found in the first part, the username, corresponding to the first search item, can be obtained based on the number of words in the first part as disclosed herein.

The method 100 may further comprise, in response to the first part comprising zero dot symbols, determining 204 number of words in the first part.

The method 100 may further comprise, in response to the first part comprising zero words, returning 205 an error.

Herein, returning an error may comprise, for example, providing an indication that an error has occurred to, for example, a software function/method/sub-program/subroutine, a module, a device. For example, if the method 100 is implemented as a software function, the function can return an indication that an error occurred during executing the function to the procedure calling the function. Returning an error may further comprise returning other information related to the error, such as the text data that caused the error.

The method 100 may further comprise, in response to the first part comprising one word, using 206 the word as the username.

The method may further comprise, in response to the first part comprising more than one word, adding 207 a dot symbol between last two words in the first part and using the last two rods and the dot symbol as the username.

According to an embodiment, the obtaining the first search item based at least on the at least one location of the second anchor section in the first part comprises: dividing the first part into a first plurality of subparts according to the at least one location of the second anchor section in the first part; and obtaining the first search item by placing at least one second anchor symbol between two subparts in the first plurality of subparts.

Herein, dividing a part into subparts according to the at least one location of an anchor section may comprise splitting the part at each location of the anchor section and thus obtaining the plurality of subparts. For example, if the first part comprises “teppo dot testaaja” and the second anchor section corresponds the dot symbol, the first part may be split into a first subpart “teppo” and a second subpart “testaaja” based on the word “dot” corresponding to the second anchor section.

For example, in the embodiment of FIG. 2, when at least one dot symbol is found in the first part, the first part can be divided into subparts based on the location(s) of the dot symbol(s). Each subpart may comprise any number of words. The username can then be constructed by, for example, adding dot symbols between the subparts as disclosed herein.

The method 100 may further comprise, in response to the first part comprising one dot symbol, checking 208 whether the first part comprises two words separated by the dot symbol. In response to the first part not comprising two words separated by the dot symbol, the method may return 205 an error. In response to the first part comprising two words separated by the dot symbol, the method may use 209 the two words and the dot symbol as the username.

The method 100 may further comprise, in response to the first part comprising two dot symbols, checking 210 whether the first part comprises three words separated by dot symbols. In response to the first part not comprising three words separated by dot symbols, the method may return 205 an error. In response to the first part comprising three words separated by dot symbols, the method may use 211 the three words and the dot symbols as the username.

The method may further comprise, in response to the first part comprising more than two dot symbols, returning 205 an error.

The processing based on the number of dot symbols in the first part may be generalized for any number of dot symbols. For example, in some embodiments, the method 100 may further comprise, in response to the first part comprising n dot symbols, checking whether the first part comprises n+1 words separated by dot symbols. Thus, this may be performed instead of returning and error as in the embodiment of FIG. 2 for n>2. In response to the first part not comprising n+1 words separated by the dot symbols, the method may return an error. In response to the first part comprising n+1 words separated by the dot symbols, the method may use the n+1 words and the n dot symbols as the username.

After obtaining the username, corresponding to the first search item, in one of operations 206, 207, 209, 211, the method may comprise obtaining 212 the second part after the @-symbol.

The method may further comprise determining 213 a number of dot symbols in the second part.

According to an embodiment, the method 100 further comprises, in response to not finding at least one of the second anchor section in the second part, obtaining the second search item based at least on a number of sections in the second part.

According to an embodiment, the method 100 further comprises, in response to not finding at least one of the second anchor section in the second part, dividing the second part into the second plurality of subparts according to sections in the second part.

For example, in the embodiment of FIG. 2, when no dot symbols are found in the second part, the domain, corresponding to the second search item, can be obtained based on the number of words in the second part as disclosed herein.

The method 100 may further comprise, in response to the second part comprising zero dot symbols, determining 214 number of words in the second part.

The method may further comprise, in response to the second part comprising one or less words, returning 205 an error.

The method 100 may further comprise, in response to the second part comprising more than one word, adding 215 a dot symbol between first two words and using the first two words and the dot symbol as the domain.

According to an embodiment, the obtaining the second search item based at least on at least one location of the second anchor section in the second part comprises: dividing the second part into a second plurality of subparts according to the at least one location of the second anchor section in the second part; and obtaining the second search item by placing at least one second anchor symbol between two subparts in the second plurality of subparts.

For example, in the embodiment of FIG. 2, when at least one dot symbol is found in the second part, the second part can be divided into subparts based on the location(s) of the dot symbol(s). Each subpart may comprise any number of words. The domain can then be constructed by, for example, adding dot symbols between the subparts as disclosed herein.

The method 100 may further comprise, in response to the second part comprising one dot symbol, checking 216 whether the second part comprises two words separated by a dot symbol. In response to the second part not comprising two words separated by a dot symbol, the method may return an error 205. In response to the second part comprising two words separated by a dot symbol, the method may use 217 the two words and the dot symbol as the domain.

The method may further comprise, in response to the second part comprising two dot symbols, checking 218 whether the second part comprises three words separated by dot symbols. In response to the second part not comprising three words separated by the dot symbols, the method may return 205 an error. In response to the second part comprising three words separated by dot symbols, the method may use 219 the three words and the dot symbols as the domain.

The method 100 may further comprise, in response to the second part comprising more than two dot symbols, returning 205 an error.

The processing based on the number of dot symbols in the second part may be generalized for any number of dot symbols. For example, in some embodiments, the method 100 may further comprise, in response to the second part comprising n dot symbols, checking whether the second part comprises n+1 words separated by dot symbols. Thus, this may be performed instead of returning and error as in the embodiment of FIG. 2 for n>2. In response to the second part not comprising n+1 words separated by the dot symbols, the method may return an error. In response to the second part comprising n+1 words separated by the dot symbols, the method may use the n+1 words and the n dot symbols as the domain.

After obtaining the domain in one of operations 215, 217, 219, the method 100 may comprise returning 220 the username and domain for example in the format username@domain. Alternatively, the method 100 may comprise returning the username and the domain in any other form.

Herein, returning the username and the domain may comprise, for example, providing the username and the domain to, for example, a software function/method/ subprogram/subroutine, a module, a device. For example, if the method 100 is implemented as a software function, the function can return the username and the domain to the procedure calling the function. Returning the username and the domain may also be referred to as providing the username and the domain.

Although the embodiment of FIG. 2, the first search item corresponds to a username part of an email address, the second search item correspond to a domain part of the email address, the first anchor section corresponds an @-symbol, and the second anchor section corresponds to a dot symbol, the embodiment of FIG. 2 may also be applied to various other applications by replacing the first and second anchor section with appropriate symbols/words/sections.

FIG. 3 illustrates a flow chart representation of a method according to another embodiment.

The method 100 can comprise checking 301 whether the text data comprises a @-symbol.

In response to the text data comprising a @-symbol, the method 100 may comprise performing 350 appropriate processing for text data with a @-symbol. An example of such processing is disclosed in the embodiment of FIG. 2.

According to an embodiment, the method 100 further comprises, in response to not finding the first anchor section in the plurality of sections, dividing the text data into the first part and the second part based further at least on a number of sections in the text data and/or probability information about the text data.

For example, the embodiment of FIG. 3 illustrates dividing the text data into the into the first part and the second part based on the dot symbol when no @-symbol is found in the text data.

The probability information about the text data may comprise, for example, information about the format of the first search item and the second search item in the text data. The probability information can be used to choose an option in situations where there are multiple possibilities. For example, in various operations in the embodiments of FIG. 2 and FIG. 3, information is used about how many words the username and the domain are likely to comprise and the obtaining the username and the domain is performed based on such information.

The method 100 may comprise, in response to the text data not comprising a @-symbol, determining 302 the number of dot symbols in the text data.

The method 100 may further comprise, in response to the text data comprising zero dot symbols, determining 303 number of words in the text data.

The method 100 may further comprise, in response to the text data comprising less than three words, returning 304 an error.

The method 100 may further comprise, in response to the text data comprising three words, using 305 the first word in the text data as the username, adding a dot symbol between the second word and the third word, and using 306 the second word and third word separated by the dot symbol as the domain.

The method 100 may further comprise, in response to the text data comprising more than three words, adding a dot symbol between the fourth to last word and the third to last word and using 307 the fourth to last word and third to last word separated by the dot symbol as the username. The method 100 may further comprise adding a dot symbol between the second to last word and the last word and using 308 the second to last word and the last word separated by the dot symbol as the domain.

The method 100 may further comprise, in response to the text data comprising one dot symbol, determining 309 number of words in the text data including the dot symbol/word.

The method 100 may further comprise, in response to the text data comprising less than four words, returning 304 an error.

The method 100 may further comprise, in response to the text data comprising four words, determining 310 whether third word in the text data corresponds to a dot symbol/word. The method 100 may further comprise, in response to the third symbol not corresponding to a dot symbol/word, returning 304 an error.

The method 100 may further comprise, in response to the third symbol corresponding to a dot symbol, using 311 the first word as the username and using 312 the second word, third word corresponding to the dot symbol/word, and the fourth word as the domain. The third word corresponding to the dot symbol may be replaced by an actual dot symbol.

The method 100 may further comprise, in response to the text data comprising more than four words, determining 313 locations of the dot symbol/word.

The method 100 may further comprise, in response to the dot symbol/word being fourth to last word, using 314 the word before the dot symbol/word, the dot symbol/word and the word after the dot symbol as the username. The dot symbol/word may be replaced by an actual dot symbol. The method 100 may further comprise adding a dot symbol between the second to last word and the last word and using 315 the second to last word, the last word separated by the dot symbol as the domain.

The method 100 may further comprise, in response to the dot symbol/word being second to last word, adding a dot symbol between the fifth to last word and the fourth to last word and using 316 the fifth to last word and the fourth to last word separated by the dot symbol as the username. The method 100 may further comprise using 317 the word before the dot symbol/word, the dot symbol/word, and the word after the dot symbol as the domain. The dot symbol/word may be replaced by an actual dot symbol.

The method 100 may further comprise, in response to the text data comprising two dot symbols, determining 318 whether there is a word before the first dot symbol and a word after the first dot symbol. The method may further comprise, in response there not being a word before the first dot symbol and a word after the first dot symbol, returning 304 an error.

The method 100 may further comprise, in response there being a word before the first dot symbol and a word after the first dot symbol, using 319 the word before the first dot symbol, the first dot symbol, and the word after the first dot symbol as the username.

The method 100 may further comprise, determining 320 whether there is a word before the second dot symbol and a word after the second dot symbol. The method may further comprise, in response there not being a word before the second dot symbol and a word after the second dot symbol, returning 304 an error.

The method 100 may further comprise, in response there being a word before the second dot symbol and a word after the second dot symbol, using 321 the word before the second dot symbol, the second dot symbol, and the word after the second dot symbol as the domain.

The method 100 may further comprise, in response to the text data comprising more than two dot symbols, determining 322 whether the text data comprises a preconfigured structure comprising a first structure part and a second structure part. The method 100 may further comprise, in response to the text data not comprising the preconfigured structure, returning 304 an error.

The method 100 may further comprise, in response to the text data comprising the preconfigured structure, using 323 the first structure part as the username and using 324 the second structure part as the domain.

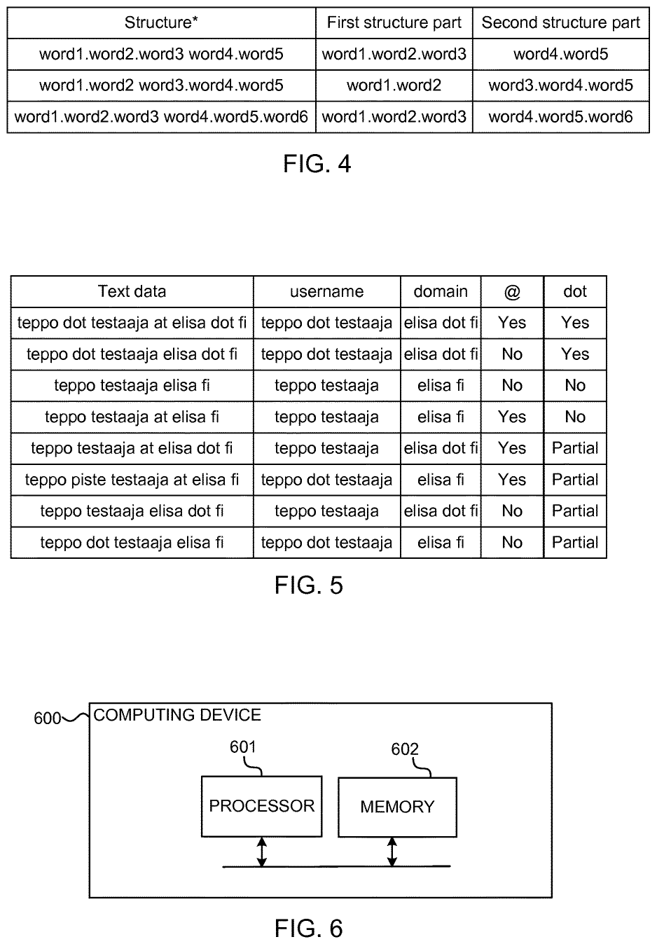

Some examples of preconfigured structures are illustrated in the embodiment of FIG. 4.

The method may further comprise, after obtaining the username and the domain, returning 330 the username and domain for example in the format username@domain. Alternatively, the method 100 may comprise returning the username and the domain in any other form.

FIG. 4 illustrates a schematic representation of a preconfigured structure according to an embodiment.

The embodiment of FIG. 4 illustrates three examples of the preconfigured structure, and how each example can be divided into the first structure part and the second structure part. Each preconfigured structure illustrated in the embodiment of FIG. 4 corresponds to text data not comprising a @-symbol and comprising three or more dot symbols. The examples illustrated in the embodiment of FIG. 4 are only exemplary and the preconfigured structure may be implemented in various alternative ways.

FIG. 5 illustrates a table of text data and corresponding usernames and domains according to an embodiment.

The text data examples in embodiment of FIG. 5 illustrate the various forms in which a user can provide the email address “teppo.testaaja@elisa.fi” in, for example, a voice-based communication when audio comprising speech of the user is converted to text data using a speech-to-text conversion. The user can, for example, pronounce special symbols, such as the @-at symbol and the dot symbol in various ways. Thus, the corresponding audio may not be converted to text correctly. Further, the user may even omit some or all such symbols when pronouncing the address as can be seen from some examples of FIG. 5. Dedicated columns in the embodiment of FIG. 5 indicate whether the text data comprises words corresponding to the @-symbol and the dot symbol. Moreover, the user may add words before and/or after the email address. For example, the user may say “Well, the email is teppo dot testaaja at elisa dot fi”. These additional words should be omitted when obtaining the username and domain from the text data.

The method 100 may be able to obtain the username and domain of the email address or relevant information components of some other information structure in various challenging situations, such as those illustrated in the embodiment of FIG. 5.

FIG. 6 illustrates a schematic representation of a computing device according to an embodiment.

According to an embodiment, a computing device 600 comprises at least one processor 601 and at least one memory 602 including computer program code, the at least one memory 602 and the computer program code configured to, with the at least one processor 601, cause the computing device 600 to perform the method 100.

The computing device 600 may comprise at least one processor 601. The at least one processor 601 may comprise, for example, one or more of various processing devices, such as a co-processor, a microprocessor, a digital signal processor (DSP), a processing circuitry with or without an accompanying DSP, or various other processing devices including integrated circuits such as, for example, an application specific integrated circuit (ASIC), a field programmable gate array (FPGA), a microprocessor unit (MCU), a hardware accelerator, a special-purpose computer chip, or the like.

The computing device 600 may further comprise a memory 602. The memory 602 may be configured to store, for example, computer programs and the like. The memory 602 may comprise one or more volatile memory devices, one or more non-volatile memory devices, and/or a com-bination of one or more volatile memory devices and non-volatile memory devices. For example, the memory 602 may be embodied as magnetic storage devices (such as hard disk drives, magnetic tapes, etc.) , optical magnetic storage devices, and semiconductor memories (such as mask ROM, PROM (programmable ROM), EPROM (erasable PROM), flash ROM, RAM (random access memory), etc.).

The computing device 600 may further comprise other components not illustrated in the embodiment of FIG. 6. The computing device 600 may comprise, for example, an input/output bus for connecting the computing device 600 to other devices.

When the computing device 600 is configured to implement some functionality, some component and/or components of the computing device 600, such as the at least one processor 601 and/or the memory 602, may be configured to implement this functionality. Further-more, when the at least one processor 601 is configured to implement some functionality, this functionality may be implemented using program code comprised, for example, in the memory.

The computing device 600 may be implemented at least partially using, for example, a computer, some other computing device, or similar.

The method 100 and/or the computing device 600 may be utilised in, for example, automatic speech recognition (ASR) application such as in a so-called voicebot. A voicebot may be configured to obtain information from users by, for example, phone and convert the voice information into text data using ASR. The method 100 may be used to obtain needed information, such as an email address, a social security number, a vehicle registration number, a product code, or a client number, from the text data. The voicebot may further be configured to further process the found information. The voicebot can, for example, ask questions about, for example, basic information from a customer in a customer service situation over the phone, obtain the answers using ASR and the method 100, and save the information in a system. Thus, the customer service situation can be made more efficient and user experience can be improved.

Any range or device value given herein may be extended or altered without losing the effect sought. Also any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems r those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the embodiments described above may be combined with aspects of any of the other embodiments described to form further embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A computer-implemented method for obtaining a first search item and a second search item from text data, the method comprising:
obtaining text data comprising a plurality of sections by obtaining speech data and converting the speech data into the text data using a speech-to-text conversion;
searching a first anchor section in the plurality of sections;
in response to finding the first anchor section in the plurality of sections, dividing the text data into a first part and a second part based on a location of the first anchor section in the plurality of sections;
in response to not finding the first anchor section in the plurality of sections, searching for a second anchor section in the plurality of sections and dividing the text data into the first part and the second part based at least on at least one location of the second anchor section in the plurality of sections;
searching for the second anchor section in the first part, and in response to finding at least one of the second anchor section in the first part, obtaining the first search item based at least on at least one location of the second anchor section in the first part;
searching for the second anchor section in the second part, and in response to finding at least one of the second anchor section in the second part, obtaining the second search item based at least on at least one location of the second anchor section in the second part; and
utilising the first search item and the second search item in an automatic speech recognition system.

2. The computer-implemented method according to claim 1, wherein the first anchor section correspond to a synonym list of a first anchor symbol and/or the second anchor section correspond to a synonym list of a second anchor symbol.

3. The computer-implemented method according to claim wherein:
the first search item corresponds to a username part of an email address or of a remote login address, the second search item correspond to a domain part of an email address or of a remote login address, the first anchor section corresponds an @-symbol, and the second anchor section corresponds to a dot symbol; or
the first search item and the second search item correspond to a social security number, a vehicle registration number, a product code, or a client number.

4. The computer-implemented method according to claim 1, the method further comprising:
in response to not finding the first anchor section in the plurality of sections, dividing the text data into the first part and the second part based further at least on a number of sections in the text data and/or probability information about the text data.

5. The computer-implemented method according claim 1, the method further comprising:
obtaining name data and obtaining the first search item based further at least on a third anchor section corresponding to the name data; and/or obtaining domain data and obtaining the second search item based further at least on a fourth anchor section corresponding to the domain data.

6. The computer-implemented method according to claim 1, the method further comprising, in response to not finding at least one of the second anchor section in the first part, obtaining the first search item based at least on a number of sections in the first part.

7. The computer-implemented method according to claim 1, the method further comprising, in response to not finding at least one of the second anchor section in the second part, obtaining the second search item based at least on a number of sections in the second part.

8. The computer-implemented method according to claim 1, wherein the obtaining the first search item based at least on the at least one location of the second anchor section in the first part comprises:
dividing the first part into a first plurality of subparts according to the at least one location of the second anchor section in the first part; and
obtaining the first search item by placing at least one second anchor symbol between two subparts in the first plurality of subparts.

9. The computer-implemented method according to claim 8, the method further comprising:
in response to not finding at least one of the second anchor section in the first part, dividing the first part into the first plurality of subparts according to sections in the first part.

10. The computer-implemented method according to claim 1, wherein the obtaining the second search item based at least on at least one location of the second anchor section in the second part comprises:
dividing the second part into a second plurality of subparts according to the at least one location of the second anchor section in the second part; and
obtaining the second search item by placing at least one second anchor symbol between two subparts in the second plurality of subparts.

11. The computer-implemented method according to claim 10, the method further comprising:
in response to not finding at least one of the second anchor section in the second part, dividing the second part into the second plurality of subparts according to sections in the second part.

12. (canceled)

13. A computing device, comprising at least one processor and at least one memory including computer program code, the at least one memory and the computer program code configured to, with the at least one processor, cause the computing device to perform the method according to claim 1.

14. A computer program product comprising program code configured to perform the method according to claim 1 when the computer program product is executed on a computer.
